(19) United States
(12) Patent Application Publication
(10) Pub. No.: US 2018/0071953 A1
(43) Pub. Date: Mar. 15, 2018

(54) METHOD FOR MOULDING TUBULAR ELEMENTS MADE FROM A MATERIAL COMPRISING CEMENT, AND PILE THUS OBTAINED

(71) Applicants: Yves BRUGEAUD, Brive (FR); CONSEIL SERVICE INVESTISSEMENTS, Paris (FR)

(72) Inventor: Yves BRUGEAUD, Brive (FR)

(73) Assignees: Yves BRUGEAUD, Brive (FR); CONSEIL SERVICE INVESTISSEMENTS, Paris (FR)

(21) Appl. No.: 15/557,626

(22) PCT Filed: Mar. 11, 2016
(86) PCT No.: PCT/EP2016/055372

§ 371 Date: Sep. 12, 2017

(30) Foreign Application Priority Data
Mar. 12, 2015 (FR) 1552061

(51) Int. Cl. B28B 21/88; B28B 23/06; B28B 23/02

(52) U.S. Cl. CPC B28B 21/88; B28B 23/024; B28B 23/06

(57) ABSTRACT

A method for moulding a part, including the following steps: placing at least one pre-stressing device in a first element; placing the first element facing a second element; pre-stressing the at least one pre-stressing device; introducing ultra-high performance fibre concrete into the reception volume; controlling gradual modification of one of the elements; and removing the tubular element from the mould.

### FIELD OF THE INVENTION

The present invention relates to the field of the manufacture of elements made from a material comprising cement and more particularly the moulding of tubular elements made from ultra-high performance fibre concrete (UHPFC).

### BACKGROUND TO THE INVENTION

Producing concrete tubular elements such as pipes or ducts by moulding is known. Conventionally, a cylindrical mould of vertical axis is placed around a tubular framework cage and a gimlet is introduced into the internal space delimited by the framework cage. The gimlet has an outside diameter corresponding substantially to the inside diameter required for the tubular element and is placed at the bottom end of the mould. Concrete is then poured by gravity into the mould while the gimlet is rotated and raised up along the axis of the mould. The combined movements of rotation and translation of the gimlet project concrete through the framework cage against the inside wall of the mould and fashion the inside wall of the tubular element. Generally, the gimlet make a single outward and return movement along the vertical axis before being withdrawn from the mould. Once the concrete is sufficiently set, the tubular element is removed from the mould and is subjected to a drying phase.

Such a method produces centrifugation of the constituents of the concrete which, more particularly in the case of UHPFCs, cause a segregation of the constituents and therefore heterogeneous distribution of the components in the concrete. As a result the element thus produced has mechanical properties very much inferior to what it should have in theory.

Alternatively, and for elements with large diameters, a rigid internal core is placed in the mould and defines the interior wall of a tubular pouring space. Concrete is introduced by gravity and vibrated in the tubular pouring space. Once the concrete has sufficiently set, the external mould is removed and the internal core is withdrawn from the tubular element. Such a manufacturing method makes it necessary to provide a surface of contact of the core with the internal wall of the tubular element that is strictly smooth and/or a suitable relief angle. Such an embodiment is unsuitable for productions in UHPFC since this material exhibits significant shrinkage. This is because shrinkage of UHPFC around a rigid core would unavoidably cause cracking of the tubular element and damage to the element when the core is withdrawn.

Thus it is not possible to carry out the moulding of tubular elements made from UHPFC by existing methods, and in particular very long elements with a small outside diameter.

When building foundations for civil engineering works, such as crossings, driving piles or micropiles is known, in order to be able to bear on the ground by spike effect or by friction. The use of piles generally requires driving and/or drilling means. The piles put in place may be prefabricated or poured on site. The driving of prefabricated piles requires the handling of solid piles, and therefore the use of lifting machinery in addition to driving machinery. There also exist injected bored piles that make to possible to inject a cement-based material into the ground. A cylindrical cavity is firstly bored in the ground and then a tubular sheath is produced against the wall of the cavity using a sheath slurry. A tube with spool is placed in the sheath and the injection material is injected at different points on the tube with spool. Under the pressure of the injection material, the sheath fractures (it is said that it “breaks down”) and enables the injection material to diffuse in the surrounding ground, then stabilising the latter. This technique is particularly advantageous, but requires having available a boring machine and skilled personnel for use thereof. All these constraints prevents the development of a crossing structure in isolated areas, in particular in developing countries where the stock of civil engineering machines is small whereas it is in these countries that the need for traffic and crossing infrastructures is the greatest.

### SUBJECT MATTER OF THE INVENTION

The aim of the invention is to produce tubular UHPFC elements by moulding, particularly in long lengths.

### SUMMARY OF THE INVENTION

To this end, according to the invention, a method is provided for moulding a part made from material comprising cement, comprising the following steps:
placing at least one prestressing device in a first element;
placing a first element facing a second element so that an external wall of one of the elements delimits, with an internal wall of the other element, a reception volume, the shape of one of the elements being modifiable gradually on demand;
introduction of the material comprising cement so as to fill the reception volume;
prestressing of the at least one prestressing device by applying a tensioning force thereto;
control of a gradual modification of the shape of one of the elements as the material comprising cement sets;
removal of the part from the mould.

Advantageously, the moulding method applies to the moulding of a tubular part made from material comprising cement, and comprises the following steps:
placing a core in a cylindrical mould so that the external wall of the core delimits a tubular reception volume with the internal wall of the mould, the shape of the core being able to be modified gradually on demand;
introduction of the material comprising cement so as to fill the tubular reception volume;
control of a gradual modification of the shape of the core as the material comprising cement sets until a core shape is obtained enabling it to be extracted from the tubular element after at least partial setting of the material comprising cement;
withdrawal of the core;
removal of the tubular part from the mould.

It is then possible to easily mould very long tubular parts without having to provide relief angles which, at small diameters and/or with elements having a closed end, would lead to a highly splayed shape. The deformation of the core accompanies the shrinkage of the material comprising cement and reduces the risks of cracking the material. The core then absorbs the shrinkage of the material while it hardens in the mould. Removing the core is easy and without risk for the integrity of the moulded tubular element.

Advantageously, the material comprising cement is ultra-high performance fibre concrete (UHPFC).

In a variant, the material comprising cement is mortar. According to a particular embodiment, the core is fabricated at least partially from wax.

Wax is a material that can be reused for a further moulding operation, non-toxic, and where control of deformation is easy. In addition, wax is a material that is advantageous for absorbing the shrinkage of UHPFC.

Advantageously, the external surface of the core is shaped so as to impart a rough surface state and/or cavities to the internal surface of the tubular pile.

This improves the attachment of any second-phase concrete that would be poured inside the tubular element.

The invention also relates to a tubular pile made from ultra-high performance fibre concrete moulded according to this method.

The invention also relates to a core with a shape that can be modified gradually on demand for implementing the method.

### BRIEF DESCRIPTION OF THE DRAWINGS

Reference will be made to the accompanying drawings, among which:

FIG. 1 is a schematic perspective view of a longitudinal section of a panel according to a first embodiment of the invention;

FIG. 2 is a schematic perspective view of a longitudinal section of a panel according to a second embodiment of the invention;

FIG. 3 is a schematic view in perspective of a longitudinal section of a panel according to a sixth embodiment of the method of the invention;

FIG. 4 is a view in exploded perspective of a mould according to the invention;

FIG. 5 is a side view of a core according to a first embodiment of the invention;

FIG. 6 is a view in cross section along the cutting plane VI-VI of the core in FIG. 5;

FIGS. 7a to 7f are schematic views in longitudinal section of the various steps of a first embodiment of the method according to the invention;

FIG. 8 is a schematic view in perspective of a core according to a second embodiment of the invention;

FIGS. 9a to 9f are schematic views in longitudinal section of the various steps of a second embodiment of the method according to the invention;

FIG. 10 is a view in cross section along the cutting plane X-X in FIG. 9b;

FIG. 11 is a schematic perspective view of a collar according to a third embodiment of the invention;

FIGS. 12.a to 12.f are schematic views in longitudinal section of the various steps of a third embodiment of the method according to the invention;

FIG. 13 is a schematic view in longitudinal section of an additional step of the third embodiment of the method according to the invention;

FIG. 14 is a schematic perspective view of a core and its associated mould according to a fourth embodiment of the invention;

FIGS. 15.a to 15.f are schematic views in longitudinal section of the various steps of a fourth embodiment of the method according to the invention;

FIG. 16 is a schematic view in longitudinal section of a preliminary step of the fourth embodiment of the method according to the invention;

FIG. 17 is a schematic perspective view of a fifth embodiment of a device according to the invention;

FIG. 18 is a detail view in perspective of FIG. 17;

FIGS. 19a to 19e are schematic views in longitudinal section of the various steps of the embodiment of the method according to the invention corresponding to the device in FIG. 16;

FIGS. 20a to 20e are schematic views in longitudinal section of the various steps of a fourth embodiment of the method according to the invention;

FIGS. 21a and 21h are schematic views in longitudinal section of the various steps of a fifth embodiment of the method according to the invention;

FIG. 22 is view in longitudinal section of a pile according to the embodiment in FIGS. 21a to 21h;

FIG. 23 is a detail view in longitudinal section of the end of the pile in FIG. 23;

FIG. 24 is a schematic view in perspective of a core for a sixth embodiment of the method according to the invention;

FIG. 25 is a detail view in longitudinal half-section of a pile according to the sixth embodiment of the method according to the invention;

FIG. 26 is identical to FIG. 25 when the pile is injected;

FIG. 27 is a schematic view of an assembled pile according to a seventh embodiment of the invention;

FIG. 28 is a schematic view of an eighth embodiment of a pile according to the invention;

FIG. 29 is a view in longitudinal section of an elbow according to ninth embodiment of the invention;

FIG. 30 is view in longitudinal section of a core according to a ninth embodiment of the invention;

FIGS. 31a to 31g are schematic views in longitudinal section of the various steps of the ninth embodiment of the method according to the invention.

### DETAILED DESCRIPTION OF THE INVENTION

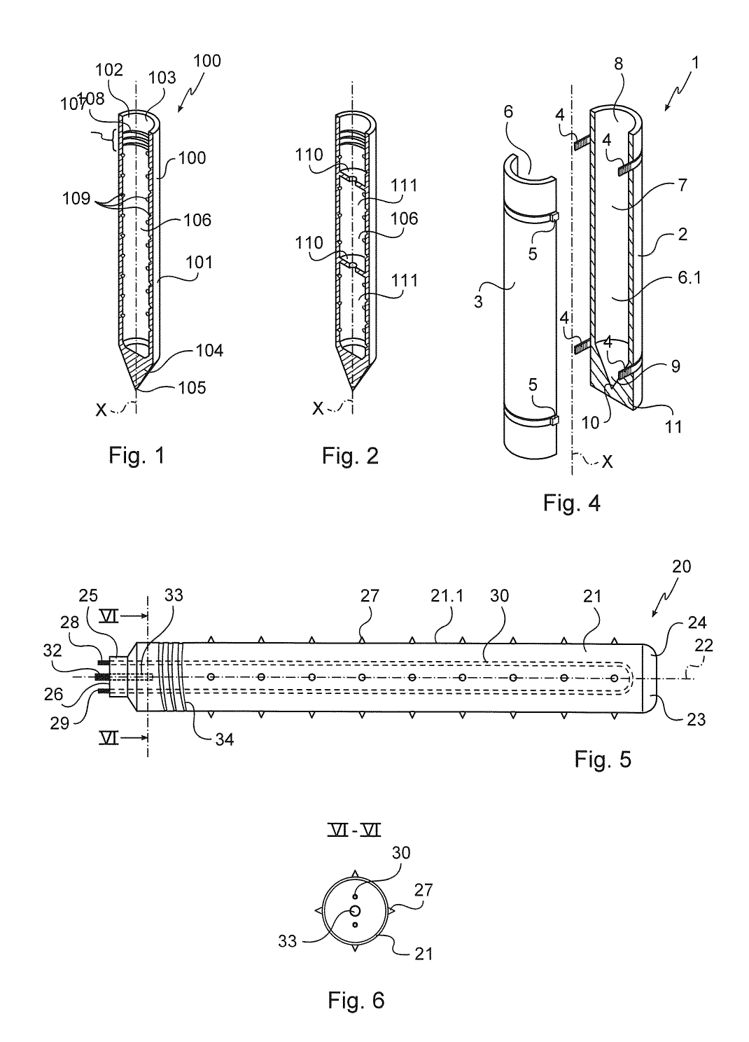

With reference to FIG. 1, the tubular element to be fabricated is a pile made from UHPFC, designated overall as 100, extending along a longitudinal axis (X). The pile 100 comprises an external wall 101 and internal wall 102. The top end 103 of the pile 100 is open and the bottom end 104 comprises a tip 105. The internal wall 102 defines an internal volume 106 with a substantially cylindrical shape and comprises a first top portion 107 provided with circular serrations 108. The pile 100 here has an outside diameter of 200 millimetres.

According to a second embodiment shown in FIG. 2, the pile 100 may comprise walls 110 with an annular shape extending radially in the volume 106 in order to divide it into a plurality of compartments 111.

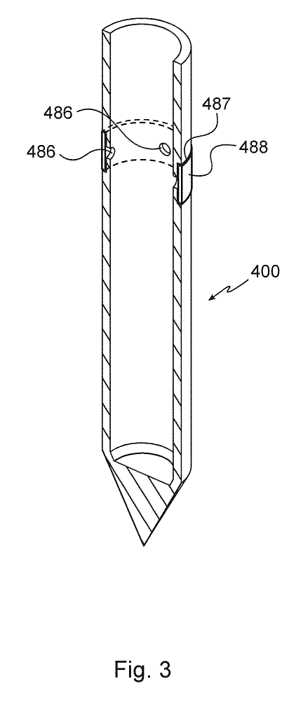

Finally, according to a particular embodiment shown in FIG. 3, the pile 400 comprises four radial channels 486 for connection between the internal volume 406 of the pile 400 and an external peripheral groove 487 in which a polymer ring 488 extends.

A first embodiment of a method for moulding a pile 100 is described with reference to FIGS. 3 to 6. This first embodiment of the method according to the invention uses a mould 1 and a core 20.

With reference to FIG. 4, the mould 1 is a cylindrical mould extending along a longitudinal axis (X) and separated into two half-moulds 2 and 3 along a plane containing the longitudinal axis (X). The half-moulds 2 and 3 are provided with means for securing them to each other, here in the form of notched tongues 4 secured to the half-mould 2 and intended to cooperate with wedging catches 5 secured to the half-mould 3. The internal wall 6.1 of the mould 1 formed by the assembly of two half-moulds 2 and 3 defines a volume 6 comprising a cylindrical portion 7 open at the top end 8 of the mould 1 and a conical portion 9, the tip 10 of which closes the volume 6 at the bottom end 11 of the mould 1.

With reference to FIG. 5, the core 20 comprises a cylindrical casing 21 made from flexible silicone extending along a longitudinal axis 22. The outside of the casing 21 defines an external wall 21.1 of the core 20. A first end 23 of the casing 21 is closed by a substantially spherical cap 24 while the other end 25 is closed by a plug 26. The external wall 21.1 comprises conical protuberances 27 for wedging the positioning of the core 20 projecting in directions substantially perpendicular to the longitudinal axis 22. The plug 26 has passing through it an inlet end 28 and an outlet end 29 of a pipe 30 for circulation of a refrigerating fluid 31 in the form of a U and extending along the longitudinal axis 22. The plug 26 also has passing through it an end 32 of a pipe 33 for filling the casing 21 with water and drainings therefrom. According to a preferred embodiment, the external wall 21.1 has a rough surface state as well as circular serrations 34 on a portion of approximately 300 millimetres measured from the end 25.

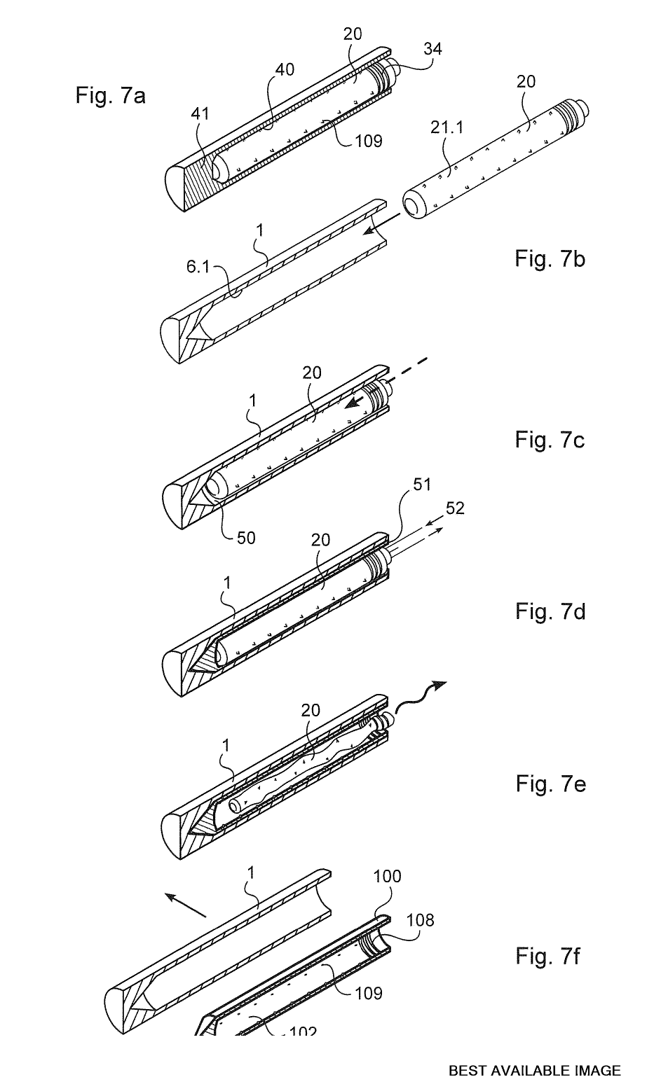

According to a preliminary step of the first embodiment of the moulding method, the casing 21 is placed in a chamber 40 of a mould 41, the internal wall of which has a shape identical to the required external shape of the core 20 (FIG. 7a). Once the casing 21 is in place, a water-feed pipe is connected to the end 32 of the pipe 33. The casing 21 is filled with water and is then pressed against the internal wall of the chamber 40. When it is completely filled with water, the casing 21 adopts the shape of the internal wall of the chamber 40. A refrigerating fluid 31 is then put in circulation in the pipe 30 and solidifies the water in the casing 21, transforming it into ice. The casing 21 thus shaped is then removed from the mould, for example by separating the mould 41 into two half-moulds. Then a core 20 having a solidified casing 21 having a defined shape, here namely a cylinder provided with conical protuberances, is obtained.

The core 20 is then placed in the mould 1 so that the external wall 21.1 of the core 20 delimits, with the internal wall 6.1 of the mould 1, a reception volume 50 (FIGS. 7b and 7c). The distal ends of the conical protuberances 27 of the core 20 come into contact with the internal wall 6.1 of the mould 1 and effect the centring of the core 20 in the mould 1 as well as a localised reduction in wall thickness of UHPFC of such a nature as to facilitate the breakdown of the wall in the case of injection of the pile. At the following step, the injection of UHPFC 51 is carried out so as to fill the reception volume 50 (FIG. 7d). As the UHPFC 51 sets, a hot heat-transfer fluid 52 is put in circulation in the pipe 30. Under the effect of the heat of the fluid 52, the ice contained in the casing 21 liquefies and the melted water is discharged through the pipe 33. This makes it possible to control a gradual modification of the shape of the core 20 that accompanies the shrinkage of the UHPFC 51. Once the major part of the ice contained in the casing 21 has been liquefied and discharged, in the end a shape of the core 20 enabling it to be extracted from the inside of the moulded pile 100 is obtained. The core 20 is then withdrawn (FIG. 7e) and the two half-moulds 2 and 3 are separated, enabling the pile 100 to be removed from the mould (FIG. 7f). Then a pile 100 made from UHPFC is obtained, the internal wall 102 of which has a rough surface state as well as circular serrations 108 in its top part, resulting from the respective impression of the surface state, and circular serrations 34 on the external wall 21.1 of the core 20. The internal wall 102 of the pile also comprises conical cavities 109 resulting from the impression of the conical centring protuberances 27 of the core 20.

The elements identical or similar to those described above will bear a numerical reference identical to these in the following description of the second, third, fourth, fifth, sixth, seventh and eighth embodiments of the method according to the invention for moulding a UHPFC pile.

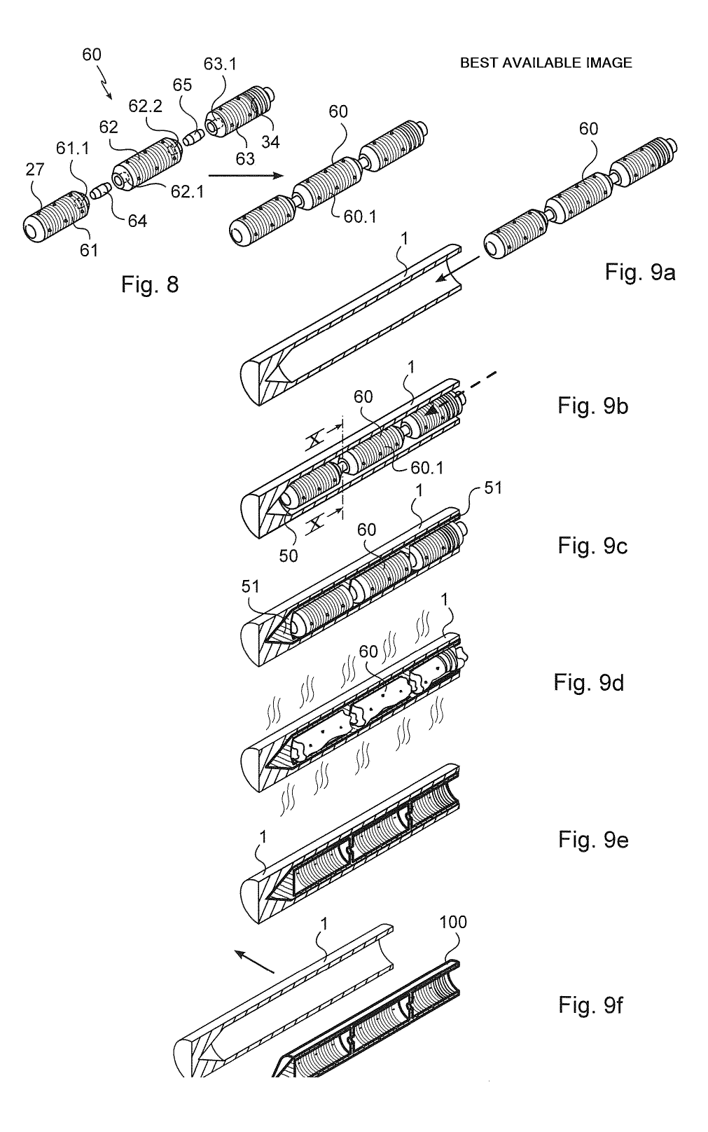

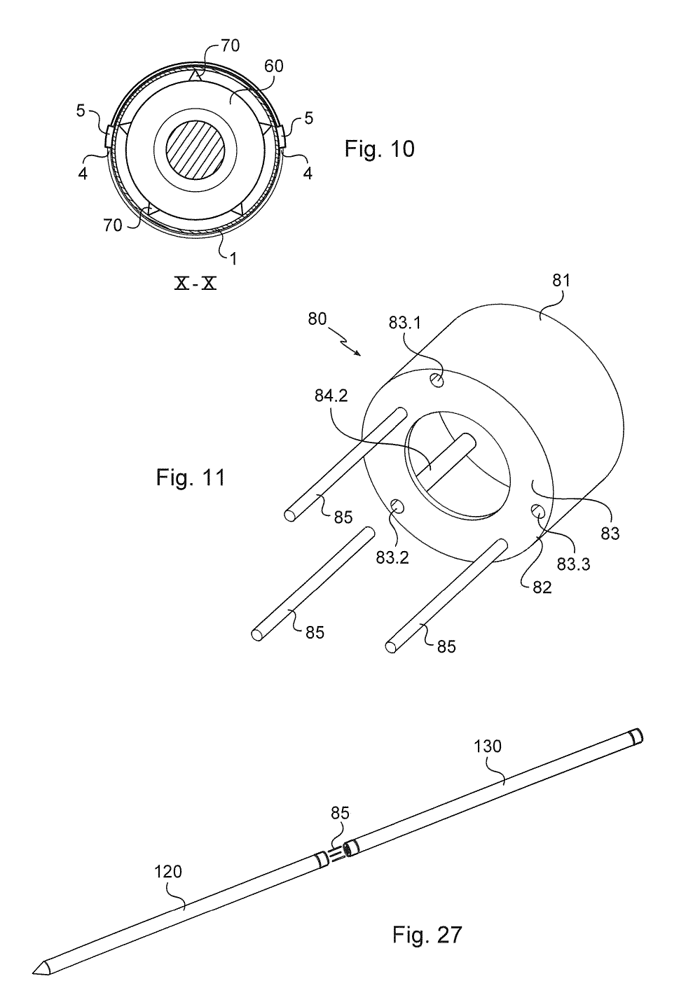

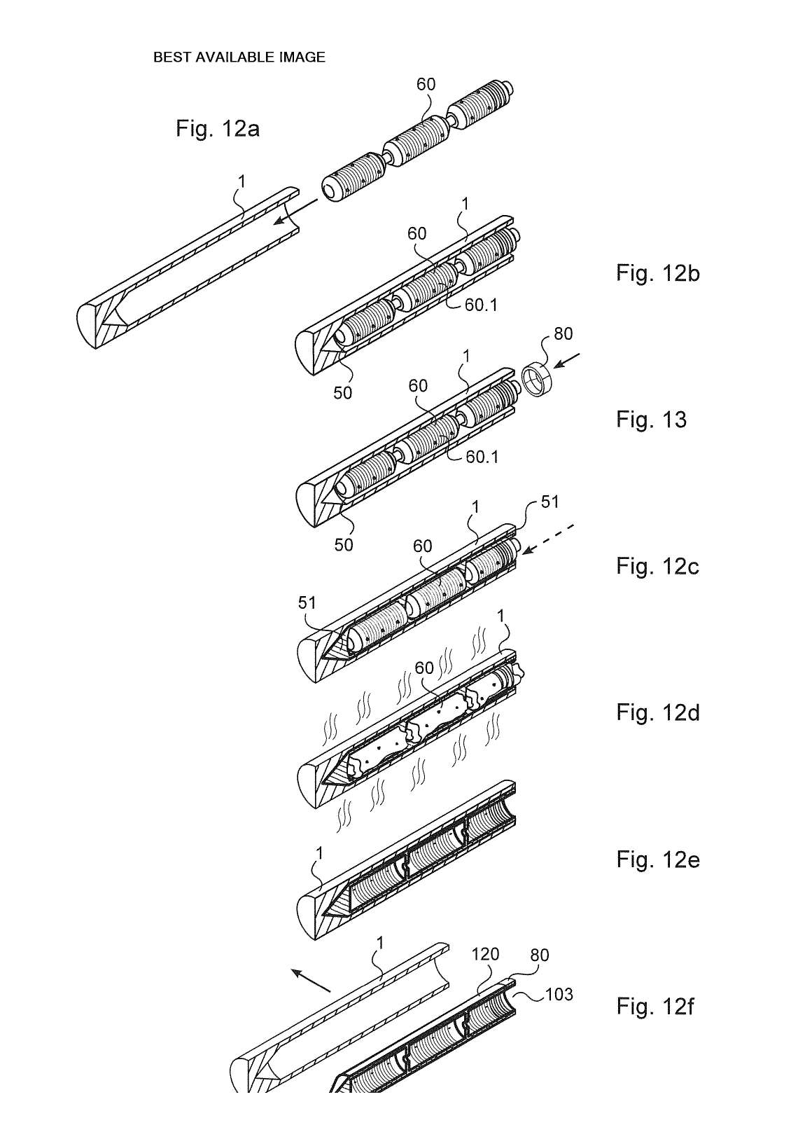

The second embodiment of the method involves the mould 1 and a core 60 produced from wax elements. With reference to FIG. 8, the core 60 comprises three cylindrical wax elements: a tip element 61, an intermediate element 62 and an end element 63 connected together by wax shafts 64 and 65 cooperating with axial cylindrical cavities 61.1, 62.1, 62.2 and 63.1 in the elements 61, 62 and 63. Each element 61, 62 and 63 comprises conical protuberances 23 and a rough surface state. The end element 63 also comprises circular serrations 34. Thus the external wall 60.1 of the core 60 is provided with a rough surface state and circular serrations 34. The core 60 is first of all placed in the mould 1 so that its external wall 60.1 delimits, with the internal wall 6.1 of the mould 1, a reception volume 50 (FIGS. 9a and 9b). As shown in FIG. 9, it may be advantageous to first dispose on the core 60 (for example by adhesive bonding), centring wedges 70 with a substantially conical shape in order to centre the core 60 in the mould 1. The centring wedges 70 may advantageously be produced from silicone. At the following step, injection of UHPFC 51 is carried out so as to fill the reception volume 50 (FIG. 9c). As the UHPFC 51 sets, the core 60 is heated, here by the injection of hot water or steam expanded on and in the core, for example by means of a cannula. Under the effect of the heat, the wax of the elements 61 to 65 softens and causes a gradual modification of the shape of the core 60, which accompanies the shrinkage of the UHPFC 51 (FIG. 9d). The core 60 is extracted from the inside of the moulded pile 100 when the elements 61 to 65 have entirely melted (FIG. 9e). The two half-moulds 2 and 3 are separated and the pile 100 is removed from the mould (FIG. 9f). Then a UHPFC pile 100 is obtained, the internal wall 102 of which has a rough surface state, and circular serrations 108 in its top part, resulting from the respective impression of the surface state, and from the circular serrations 34 on the external wall 61.2 of the core 60.

According to a third embodiment, the method comprises the additional step of disposing a metal collar 80 at the entrance of the mould 1 prior to the introduction of the UHPFC into the mould 1. With reference to FIG. 11, this collar 80 comprises a straight cylinder portion 81, one end 82 of which comprises a radial annular portion 83. The portion 83 comprises three circular piercings 83.1, 83.2 and 83.3 emerging respectively on cylindrical sleeves 84.1, 84.2 and 84.3, the end of which opposite to the portion 83 is closed. The sleeves 84.1 to 84.3 also contribute to the securing of the collar 80 to the UHPFC and are adapted to receive cylindrical rods 85. Steps 12.a to 12.f of the method according to this third embodiment are identical to steps 9.a and 9.f of the second embodiment of the method. However, an additional step, shown in FIG. 13, consists of disposing a metal collar 80 at the entrance of the mould 1 prior to the introduction of the UHPFC into the mould 1. The UHPFC pile 120 thus obtained then comprises a collar 80 that makes it possible to preserve the top end 103 of the pile 120 when it is driven.

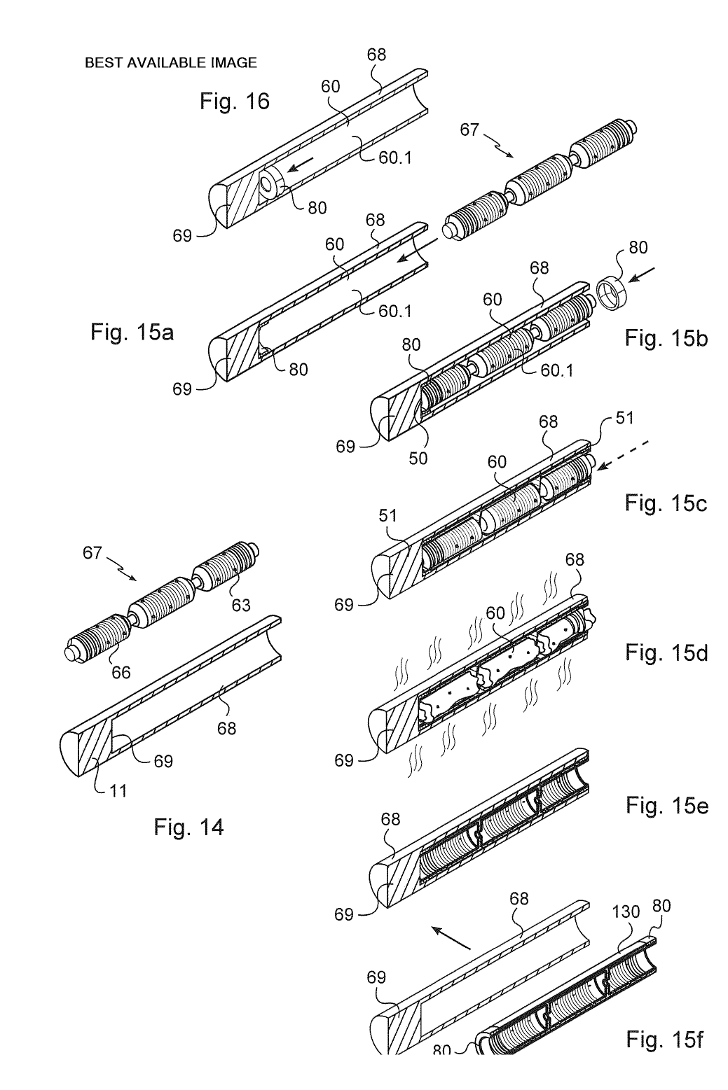

According to the fourth embodiment described with reference to FIGS. 14 and 15, the tip portion 61 of the core 60 is replaced by a portion 66 identical to the end portion 63 (FIG. 14). The core 67 thus obtained is intended to be placed in a mould 68 similar to the mould 1 but the conical portion 9 of the bottom end 11 of which is replaced by a planar transverse portion 69. Steps 15a to 15f of the method according to this fourth embodiment correspond to steps 12a to 12f and 13 of the third embodiment of the method. However, an additional step, shown in FIG. 16, consists of disposing a metal collar 80 at the bottom end 11 of the mould 1 prior to the introduction of the core 67 into the mould 1. The UHPFC pile 130 thus obtained then comprises a first collar 80 at its bottom part and a second collar 80 at its top part. The collars 80 make it possible to protect the ends of the piles 120 and 130 when they are driven and also allow the securing of the top end of the pile 120 or 130 to the bottom end of a pile 130 by welding two adjacent collars 80.

The piles 100, 110 and 120 can advantageously be driven into the ground and easily leveled off when they can be driven no further. This has an advantage compared with prefabricated driven piles in terms of handling and implementation time. This is because the tubular piles 100 and 110 are lighter than solid prefabricated piles and can be cut more easily. The piles 100 and 110 can also be placed in boreholes and subsequently receive a metal reinforcement and/or a cement or concrete slurry in a second phase. Finally, these piles 100 and 110 can also be used for effecting an injection in soils. In the case of such use, peripheral piercings in the pile 100 or 110 can be carried out in the factory or on site if it is wished to use injection pumps of moderate power and with pumps with a higher power, the pile can be broken in line with the conical protuberances 21 because of the local lesser thickness of the pile 100 at this point.

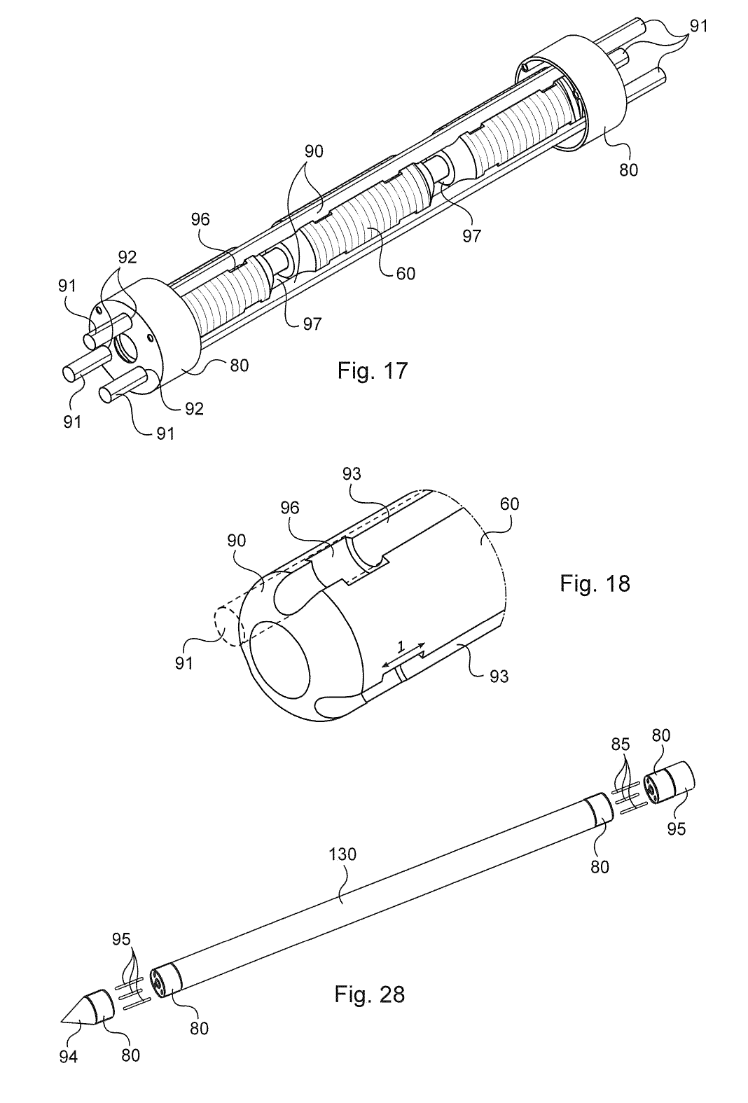

According to a fourth particular embodiment detailed in FIGS. 17 and 18, the core 60 is centred by means of three prestressing wires 90. The wires 90 are notched and of relatively small diameter, here four millimetres in diameter. These wires 90 extend between two collars 80 placed at the ends of the mould 1 and which receive the ends 91 of these wires in piercings 92. As can be seen in FIG. 17, the core 60 comprises three semi-cylindrical longitudinal grooves 93, the walls of which come into contact with at least part of the external surface of the wires 90. Semi-cylindrical recesses 96 with a diameter greater than that of the grooves 93 extend coaxially thereto over portions of length l regularly distributed over the length of each groove 93. Additionally, the core 60 also produces recesses 97 corresponding to the volumes situated vertically in line with the intermediate elements 62. These recesses are preferentially situated at 600 millimetres from each other and have a length l of 80 millimetres. Ideally, the recesses 96 have a diameter 12 millimetres greater than the wires 90.

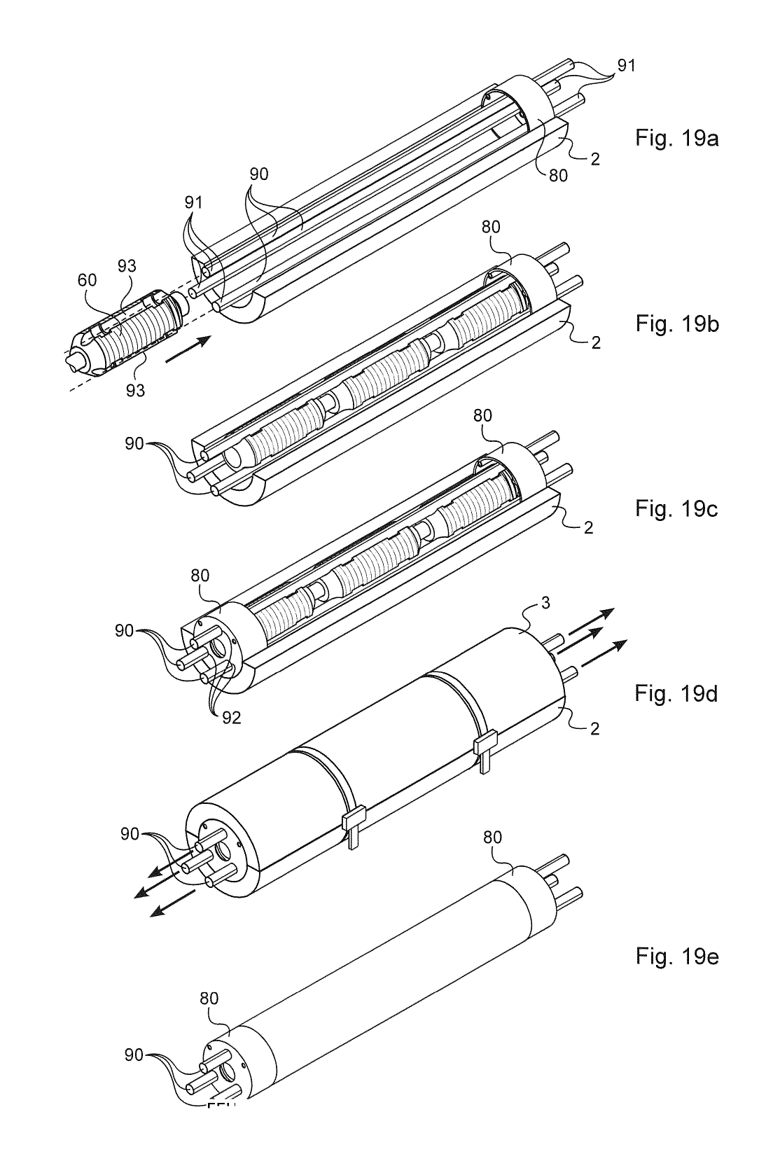

The manufacture of a pile 130 according to the fourth embodiment will be described with reference to FIGS. 91a to 19e.

The ends 91 of the wires 90 are passed through the piercings 92 of a first collar 80 positioned at a first end of the half-mould 2 and extend over the entire length thereof (FIG. 19a). The core 60 is offered up so as to align the grooves 93 with the ends 91 of the wires 90. The core 60 is next slid between the cables 90, guided by the latter (FIG. 19b). A second collar 80 is put in place at the second end of the half-mould 2 and the ends 91 of the wires 90 are passed through piercings 92 (FIG. 19c). The half-mould 3 is fixed to the half-mould 2 and the ends 91 of the wires 90 are tensioned in order to pre-stress the wires 90 (FIG. 19d). The core 60 is held in position between the wires 90 engaged in the grooves 93 and is then centred in the mould 1, delimiting the reception volume 50. The steps of pouring the UHPFC and of extraction of the core 60 are identical to those disclosed previously. The recesses 96 and 97 are filed with UHPFC during pouring and provide both effective anchoring of the wires 90 and sufficient cladding (here a minimum of six millimetres for the recesses 96) around the wires 90. Once the UHPFC has completely set, the tension applied to the ends 91 of the wires 90 is released and the pile 130 is removed from the mould (FIG. 19e). The free ends 91 of the wires 90 can be used to handle the pile 130. This embodiment is also suited to the centring of the core 20 with a flexible casing.

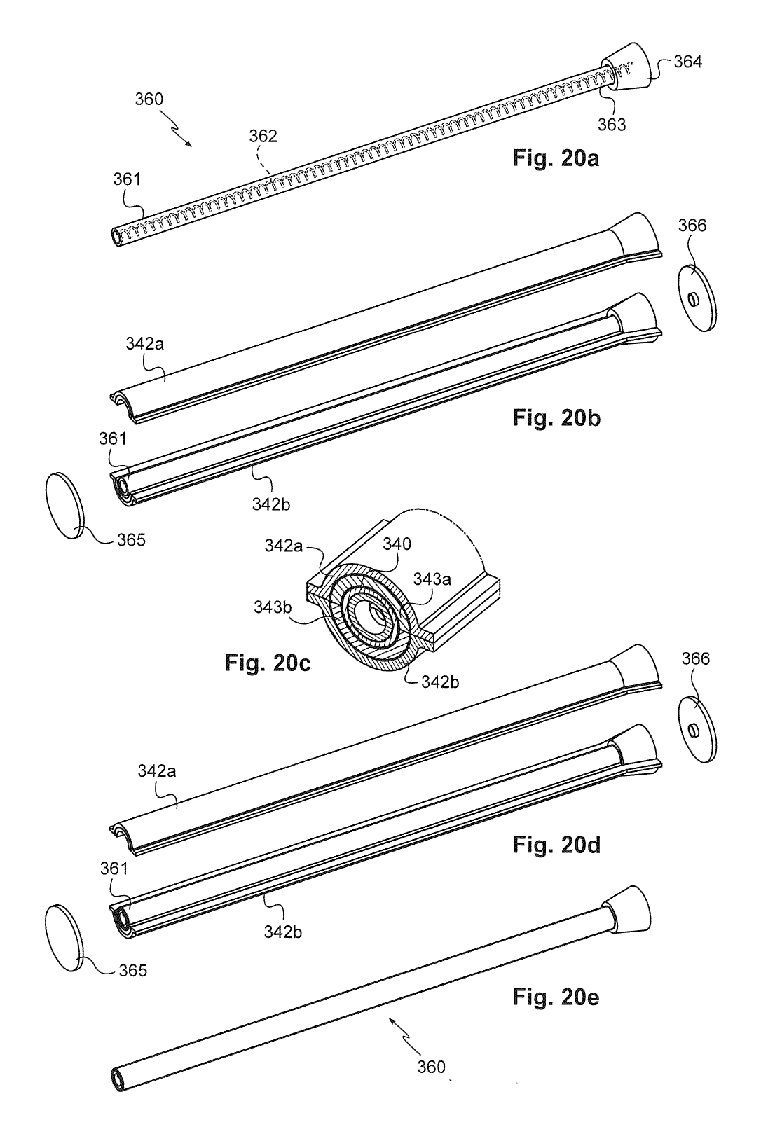

The fifth embodiment of the moulding method according to the invention relates to the production of a tubular pile 300 and involves a core 360 produced by means of a mould 341, according to a method shown in FIGS. 20a to 20d.

The core 360 comprises a metal tube 361, here a straight cylinder, on the internal face of which an electrical heating braid 362 makes a spiral. The heating braid 362 is sized so as to generate temperatures on the surface of the tube 361 of between 30 and 120 degrees centigrade. The core 360 also comprises, in its first end 363, a polymer collar 364 provided with a central orifice (FIG. 20a). Two metal half-shells 342a and 342b internally clad respectively with a half-jacket 343a and 343b made from polymer are placed on either side of the tube 361 and secured around the latter (FIG. 20b). Closure plates 365 and 366 close the ends of the mould 341 so as to define, conjointly with the half-shells 342a and 342b, a tubular injection chamber 340 around the tube 361 (FIG. 20c). A wax 366 in the liquid state (molten) is next injected into the chamber 340 so as to clad the tube 361. Once the wax 366 has cooled, the core 360 composed of the tube 361 clad with the layer of wax 366 and comprising the collar 364 is removed from the mould (FIGS. 20d and 20e). Operations of shaping the layer of wax 366 via machining can be carried out so as to confer the required profile on it. Preferentially, the wax 366 has a softening point between 75 and 115 degrees centigrade. Even more preferably, the wax 366 has a softening point of between 75 and 115 degrees centigrade. Still preferably, the wax 366 has a melting point above 115 degrees centigrade. The thickness of the layer of wax 366 cladding the core 360 is generally between five and fifty millimetres.

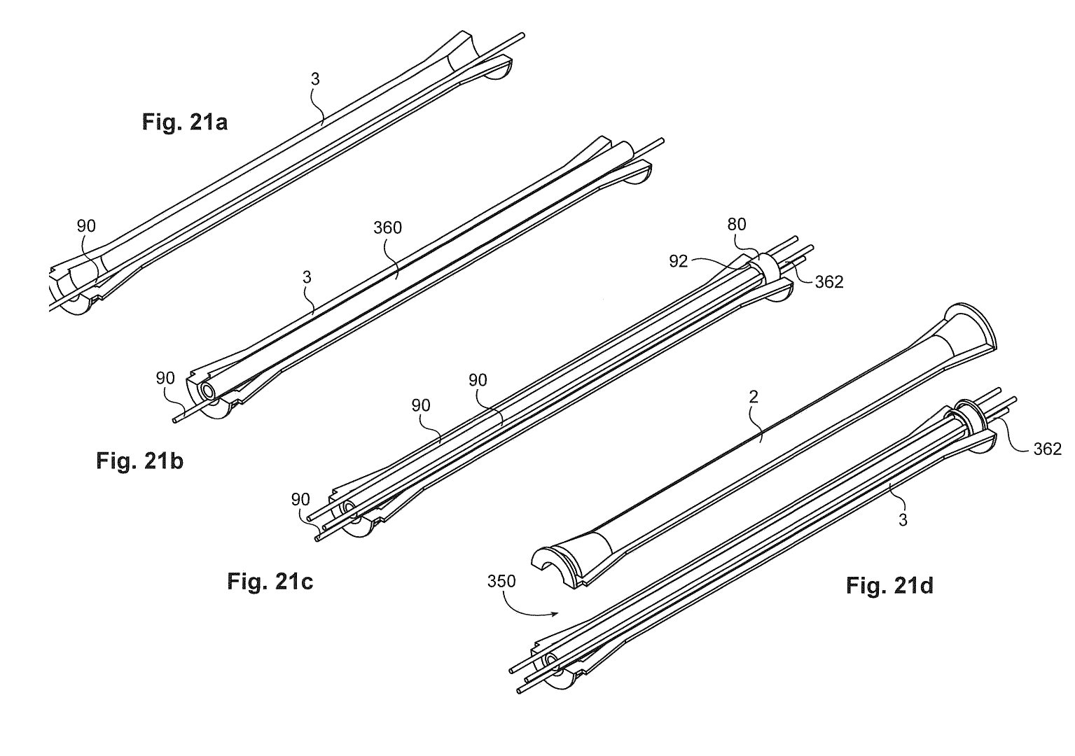

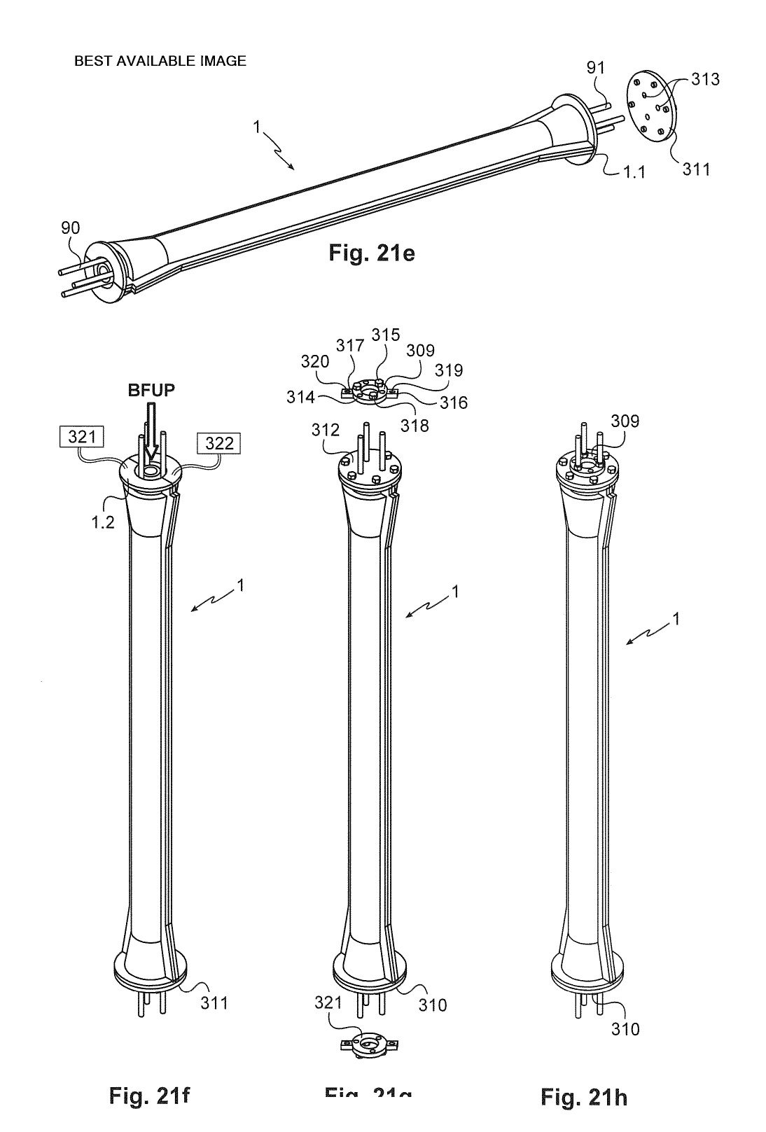

The manufacture of a pile 300 according to the fifth embodiment will be described with reference to FIGS. 21a to 21d.

A first wire 90 is placed in the half-mould 3 (FIG. 21a), extending over the entire length thereof. The first wire 90 extends beyond the ends of the half-mould 2. The core 360 is next placed facing the half-mould 2 (FIG. 21b). The second and third wires 90 are next placed around the core 360 and the end 91 of the wires 90 are passed through the piercings 92 of a first collar 80 placed in the vicinity of the end 362 of the core 360 (FIG. 21c). The half-mould 3 is placed facing the half-mould 2 and secured thereto, thus delimiting a reception volume 350 (FIG. 21d). A first butt plate 311 (here a circular flange) comprising orifices 313 for passage of the ends 91 of the wires 90 is attached by bolting to a first end 1.1 of the mould 1 (FIG. 21e).

The mould 1 is then disposed vertically and filled with UHPFC through its second open top end 1.2. A first UHPFC thermocouple 321 and a second wax thermocouple 322 are respectively disposed in the UHPFC and in the layer of wax 366 of the core 360 (FIG. 21f). The UHPFC thermocouple 321 and the wax thermocouple 322 make it possible to measure the respective changes in temperature of the wax and UHPFC during the moulding process. A second butt plate 312, identical to the first butt plate 311, is attached by bolting to the second end 1.2 of the mould 1 and closes the mould 1 (FIG. 21g).

The mould 1 also comprises means for prestressing the wires 90. These are in the form of two identical pre-stressing mechanisms 309 and 310 (FIG. 21h). The pre-stressing mechanism 309 comprises a plate 314 provided with three piercings 315, two threaded holes 316 and 317 and sockets 318 for locking each wire 90. The locking sockets 318 come into abutment on the face of the plate 311 opposite to the one facing the butt plate 312. Two CHC screws 319 and 320 are engaged in the threaded holes 316 and 317 so that their ends bear on the butt plate 312. The pre-stressing mechanism 310 facing the butt plate 311 is identical to the pre-stressing mechanism 309.

After pouring and closure of the mould 1, the wires 90 are prestressed by applying a tensioning force by means of the prestressing mechanisms 309 and 310 by tightening the screws 319 and 320.

The measurement of the temperature of the UHPFC by means of the UHPFC thermocouple 321 makes it possible to detect a rise in the temperature thereof, which marks the start of the hardening of the UHPFC. A first temperature set point is sent to the heating braid 362 in order to establish a temperature of sixty degrees centigrade in the layer of wax 366 of the core 360. Preferentially, the first temperature set point is between fifty and seventy five degrees centigrade.

The wax thermocouple 322 can be used to establish a temperature regulation of the core 366 by coupling with the heating braid 362.

This temperature set point brings the layer of wax 366 of the core 360 to a temperature of sixty degrees centigrade, which makes it possible to apply a heat treatment to the UHPFC (here an acceleration of the hardening thereof) without the geometry of the core 360 being modified under the effect of the heating of the wax 366 since the heat treatment temperature is below the softening point according to the ball and ring method of the wax 366. Preferably, the heat treatment of the UHPFC has a duration of between 120 and 420 minutes.

Monitoring the change in the temperature of the UHPFC also makes it possible to anticipate the moment when the UHPFC begins to shrink. A second temperature set point sent to the heating braid 362 is then raised to a temperature of eighty five degrees centigrade. Preferentially, the second temperature set point is between seventy five and one hundred degrees centigrade. This second temperature set point brings the layer of wax 366 of the core 360 to a temperature of eighty five degrees centigrade, which causes softening of the layer of wax 366 of the core 360 since the second temperature set point is higher than the softening temperature according to the ball and ring method of the wax 366. Preferably, the heat treatment of the UHPFC has a duration of between 60 and 120 minutes. This softening of the was 366 enables the latter not to oppose the shrinkage of the UHPFC when it hardens, which has the effect of limiting or even eliminating the cracking of the UHPFC.

Monitoring the change in the temperature of the UHPFC also makes it possible to define the quantity of heat to which the pile 300 is subjected during moulding and therefore to estimate the moment as from which the pile 300 has sufficient mechanical strength to be prestressed.

A step of removal from the mould is then triggered. In this step, a third temperature set point is sent to the heating braid 362 in order to raise the temperature to one hundred and twenty degrees centigrade. Preferentially, the third temperature set point is between one hundred and one hundred and twenty degrees centigrade. This third temperature set point brings the layer of wax 366 of the core 360 to a temperature of one hundred and twenty degrees centigrade, which causes the at least partial liquefaction of the layer of wax 366 of the core 360 since the third temperature set point is substantially equal to the liquefaction temperature according to the ball and ring method of the wax 366. The wax can therefore be discharged from inside the pile 300 in order to be collected with a view to subsequent use.

The screws 319 and 320 are then slackened and the application of the tensioning force on the wires 90 is removed. A prestressed pile 300 is then obtained. The pile 300 is then removed from the mould by separation of the two half-mounds 2 and 3 and the butt plates 311 and 312. The collar 364 is then removed from the pile 400 with a view to subsequent use.

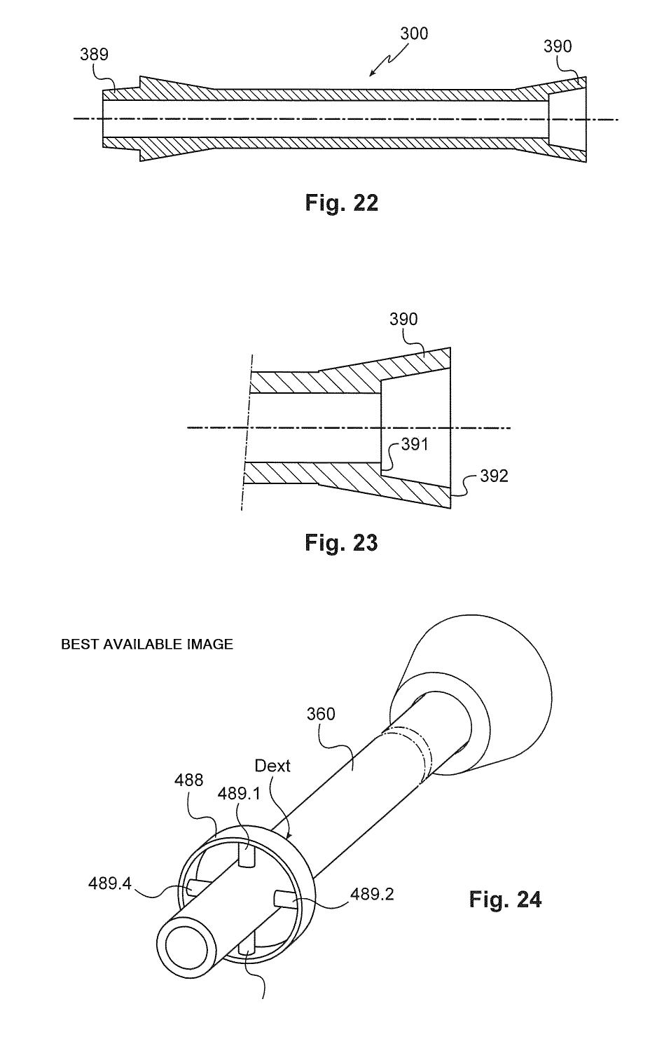

As can be seen in FIGS. 22 and 23, the interior of the end 1.1 of the mould 1 is shaped so that the first end 389 of the pile 300 has an outside diameter substantially equal to the inside diameter of the annular space left by the external face of the collar 364 in the internal wall of the pile 300 at its second end 390. The pile 300 then has a first radial shoulder 391 and a second radial shoulder 392. A first and a second pile 300 can therefore be assembled by fitting the first end of a first pile 300 in the second end of another identical pile. The driving force is applied to the first pile and then transmitted to the second pile by a contact surface corresponding to the sum of the surfaces of the first shoulder 391 and of the second shoulder 392, without the main cross section of the pile 300 being modified.

The use of the wires 90 makes it possible to establish a prestressing force in the pile 400 that greatly increases its bending strength compared with a pile with no prestressing wires. Since the phases of handling of the piles often take place flat because of their great length, the prestressing of the pile 400 makes it possible to reduce the thickness of the UHPFC wall of the pile to ratios between the normal thickness of the wall to the total diameter of the pile of less than or equal to 0.2. This makes it possible to obtain piles that are lighter, longer and less expensive by reducing the share of the UHPFC in the manufacture thereof.

A sixth particular embodiment of a pile according to the invention relates to the production of a tubular UHPFC pile 400 with integral spool. With reference to FIG. 3, such a pile 400 comprises four radial channels 486 for connection between the internal volume 406 of the pile 400 and an external peripheral groove 487 in which a polymer ring 488 extends.

The method for moulding the pile 400 is identical to that of the pile 300 but differs therefrom in that the core 360, shown in FIG. 24, comprised four protrusions 489.1, 489.2, 489.3 and 489.4 made from wax 366 extending at ninety degrees from another in radial directions. The distal part of each protrusion 489.1, 489.2, 489.3 and 489.4 joins a ring 488, here made from polymer. The outside diameter Dₑₓₜ of the ring 488 is substantially less than the outside diameter of the reception volume 350 of the mould 1. The moulding method of the sixth embodiment of the invention is identical to the fifth embodiment of the invention but differs therefrom in that the prestressing wires 90 are fitted after the fitting of the core 360 in the mould 1 so as to be able to be installed between the core 360 and the ring 488.

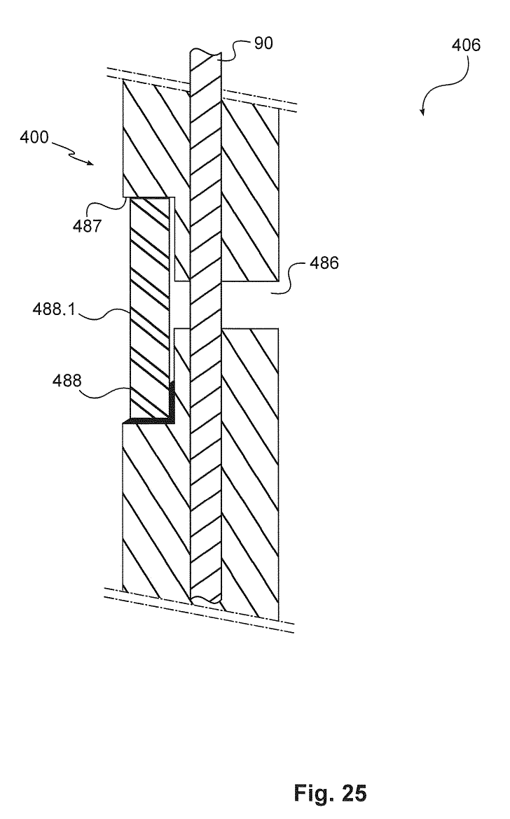

When the UHPFC is poured into the mould 1, the protrusions 489.1 to 489.4 and the polymer ring 488 create spaces in the pile 400 so as to create radial channels 486 for connection between the internal volume 406 and an external peripheral groove 487 of the pile 400. Once the core 361 and the protrusions 489.1 to 489.4 have melted, the pile 400 is removed from the mould and a pile 400 is obtained that comprises four radial channels 486 for connection between the internal volume 406 of the pile 400 and an external peripheral groove 487 in which the ring 488 extends. The external face 488.1 of the ring 488 is slightly recessed from the external face of the pile 400, which reduces friction of the ring 488 with the ground when the pile 400 is sunk. According to a particular embodiment shown in FIG. 25, one of the internal edges of the ring 488 may be bonded to the groove 487 by an injection of resin.

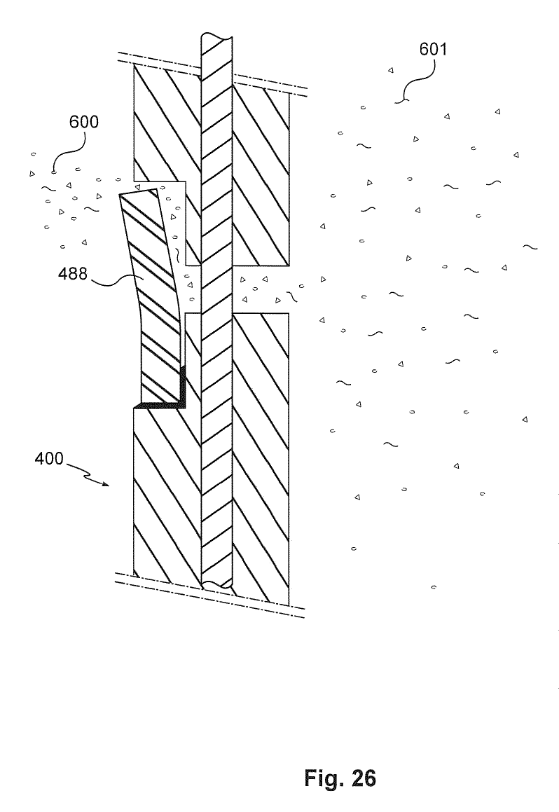

FIG. 26 shows the pile 400 after sinking thereof by driving into a ground 600. An injection material 601 is injected into the internal volume 406 of the pile 400. Under the effect of the pressure of the injection material 301 present in channels 486, the non-bonded portion of the ring 488 is pushed towards the outside of the pile 400 and enables the injection material 601 to diffuse in the ground 600, without requiring a “breakdown” of the pile 400 (FIG. 26). When the pressure of the injection material decreases, the ring 488 returns to its initial shape and closes off the channels 486, thus preventing a return of the injection material 601 injected into the ground 600 towards the internal volume 406. The configuration of the ring 488 and of the pile 400 then fulfil the function of a tube with spool of the prior art.

A pile 400 made from UHPFC is then obtained, with an integral spool that can be driven. Such a pile is economical to produce since it does not require the use of a metal or PVC tube with spools, which are expensive devices. Such a pile makes it possible to dispense with a boring installation since it is sunk in the ground by driving. Finally, the injection material can be injected at lower pressures since the pile 400 does not require “breakdown”. It is then possible to use smaller injection equipment, which results in an additional saving in implementation. According to a particular use detailed in FIG. 27 of a seventh embodiment of the invention, it is possible to assemble one or more piles 130 with a pile 120. The assembly is done by inserting cylindrical rods 85 through piercings 83.1 to 83.3 so that they are received in the sleeves 84.1 to 84.3 of the pile 120. The rods 85 have a length such that they project beyond the top end 103 of the pile 120. A pile 130 is then offered up so that the piercings 83.1 to 83.4 face the end of the rods 85 received in the sleeves 84.1 to 84.3 of the collar 80 of the pile 120. A relative translation of the piles 120 and 130 then makes it possible to engage the ends of the rods 85 in the sleeves of the collar 80 situated at the bottom part of the pile 130. The adjacent collars 80 of the piles 120 and 130 are then assembled by welding. This assembly method can be reproduced so as to produce a pile with the required length by means of prefabricated elements. Such an assembly can of course also be carried out by involving one or more tubular pile elements 300.

It is also possible, as shown in FIG. 28 and according to an eighth embodiment of the invention, to combine one or more piles 130, 300 or 400 with a solid tip element 94 produced from UHPFC and provided with a collar 80. The connection of the tip element 94 on the pile 130 is done by means of cylindrical rods 85 and the collars 80 of the tip element and of the pile 130 are welded together.

Advantageously, a solid UHPFC head element 95, also provided with a collar 80, is attached in the same way as the head element 94 on the other end of the pile 130.

This makes it possible to be able to respond to any pile configuration while storing only a small number of parts: tip elements 94, head elements 95, and piles 130, 300, 400.

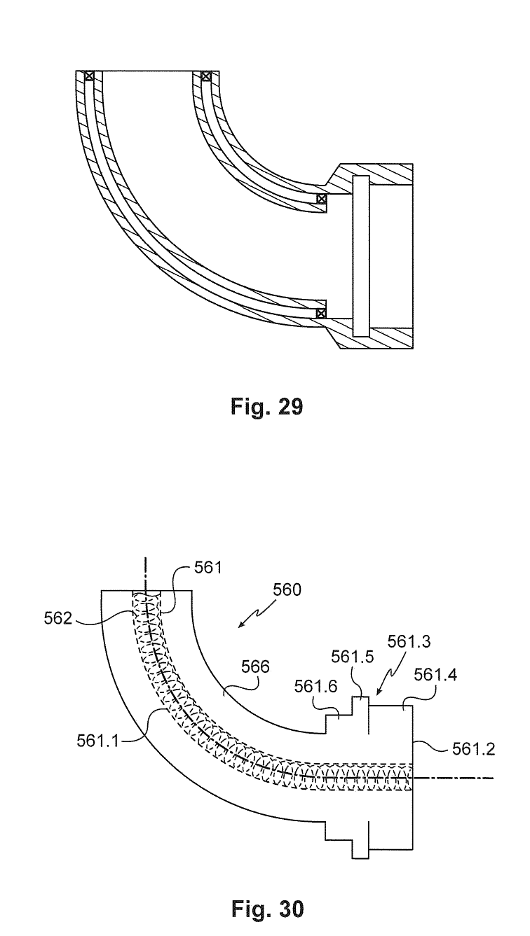

According to a ninth embodiment of the invention described with reference to FIGS. 29 to 31, the method according to the invention is here implemented for producing a part curved in its longitudinal axis, here an elbow 500 at ninety degrees (FIG. 29). Such a part makes it possible to produce networks, such as for example non-rectilinear networks for supplying water or collecting waste water.

This ninth embodiment involves a core 560 that comprises a curved metal tube 561 comprising a portion 561.1 the longitudinal axis (X) of which makes a quarter of a circle (FIG. 30). The internal face of the tube comprises an electrical heating braid 562 that makes a spiral. The heating braid 562 is sized so as to generate temperatures on the surface of the tube 561 lying between 30 and 120 degrees centigrade. A wax layer 566 is moulded onto the tube 561 in accordance with a method identical to the one described for the fifth embodiment of the invention, the mould 541 used having a suitable form, that is to say comprising a longitudinal axis portion in a quarter of a circle. Internal half-jackets 543a and 543b of the mould 541 are shaped so that one end 561.2 of the core 561 has a stepped annular protrusion 561.3 composed of three annular sections 561.4, 561.5 and 561.6, the middle section 561.5 of which has a larger diameter.

Preferentially, the wax 566 has a softening point according to the ball and ring method of between 75 and 115 degrees centigrade. Even more preferably, the wax 566 has a melting point above 115 degrees centigrade. The thickness of the layer of wax 566 cladding the core 560 is generally between 5 and 50 millimetres.

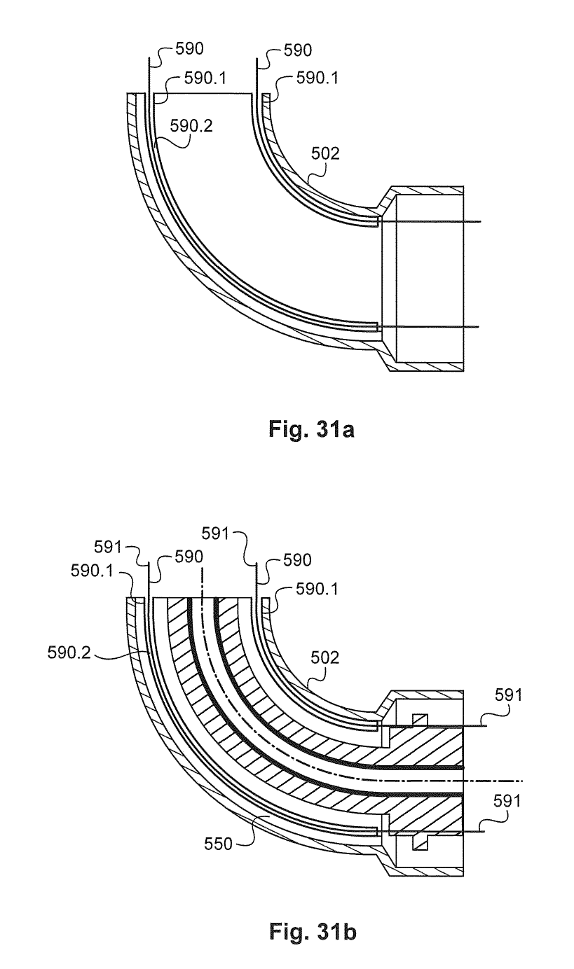

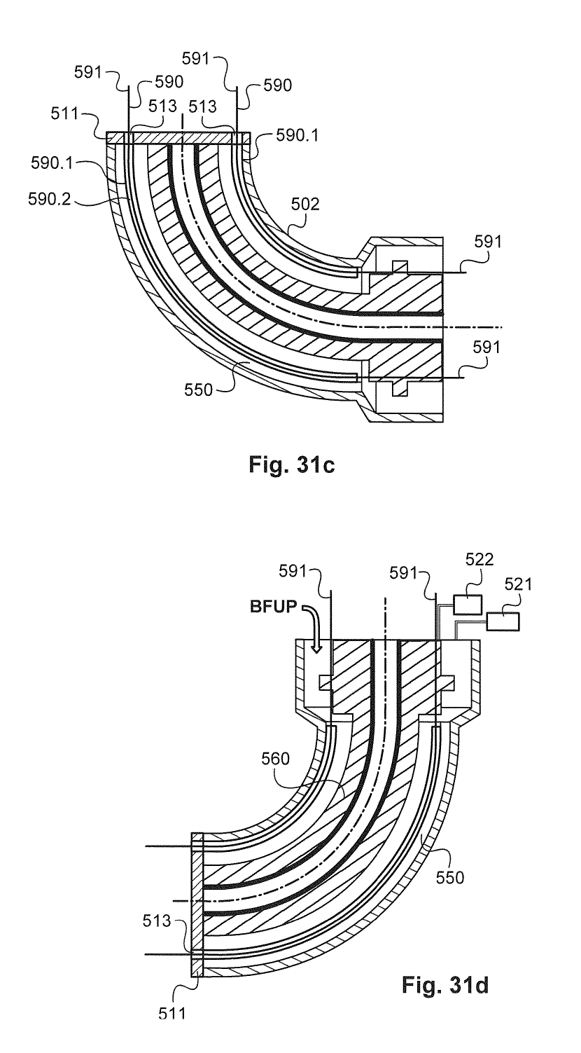

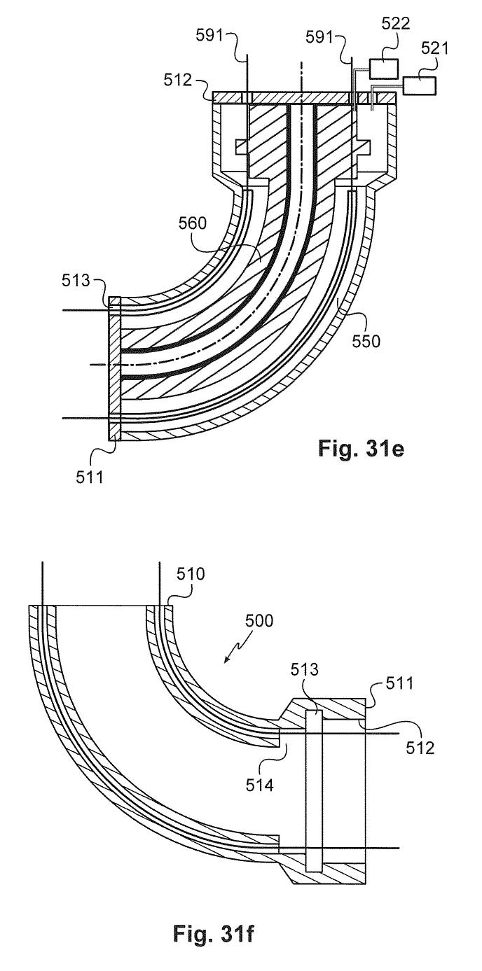

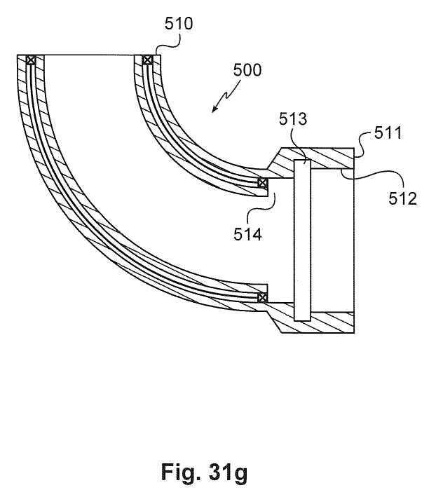

The manufacture of an elbow 500 according to the ninth embodiment will be described with reference to FIGS. 31a to 31g.

A first wire 590 enclosed in a curved sheath 590.1 filled with grease 590.2 is placed in an angled half-mould 502, the longitudinal axis (X) of which makes a quarter of a circle. A second sheath 590.1 is also positioned in the half-mould 502 (FIG. 31a). The ends 591 of the wires 590 have an excess length and extend beyond the sheath 590.1 and the ends of the half-mould 502.

The core 560 is next placed in the half-mould 502 (FIG. 31b), taking care to pass the ends 591 of the wires 590 through passages specially provided for this purpose in the protrusion 561.3. The third sheath 590.1 (not visible on the cross section in FIG. 31) is next placed around the core 560, in the same way as the other sheaths 590.1. A half-mould 503 (not shown) is offered up facing the half-mould 502 and secured thereto, thus delimiting a reception volume 550 with the core 560, in which in particular the sheaths 590.1 extend. A first butt plate 511 comprising orifices 513 for passage of the ends 591 of the wires 590 is attached by bolting to a first end 501.1 of the mould 501 composed of the half-moulds 502 and 503 (FIG. 31e).

The mould 501 is then disposed so that its second open end 501.2 extends in a horizontal plane, and the mould 501 is filled with UHPFC through its second end 501.2. A first UHPFC thermocouple 521 and a second wax thermocouple 522 are respectively disposed in the UHPFC and in the layer of wax 566 of the core 560 (FIG. 31d). The UHPFC thermocouple 521 and the waxed thermocouple 522 make it possible to measure the respective changes in the temperatures of the wax and of the UHPFC during the moulding process. A second butt plate 512, identical to the first butt plate 511, is attached by bolting on the second end 1.2 of the mould 1 and closes the mould 1 (FIG. 31e).

In this ninth particular embodiment of the method according to the invention, the prestressing of the wires 590 is not applied before the UHPFC sets.

The steps of application of the first, second and third temperature set points are identical to those of the fifth embodiment of the invention described previously and based on the same temperature measurements. After the third temperature set point and the removal of the core 560, the elbow 500 is removed from the mould by separation of the two half-moulds 502 and 503 and the butt plates 511 and 512.

The elbow 500 thus cast has a first end 510 and a second end 511 from which the ends 591 of the wires 590 project. The end 511 comprises a housing 512 with a greater diameter than the inside diameter of the elbow 500 created by the annular section 561.4 of the core 560. The annular sections 561.5 and 561.6 have respectively created annular housings 513 and 514 in the internal face of the elbow 500 (FIG. 31.f)

The first ends 591 of the wires 590 are then anchored in a known manner in the UHPFC of one of the ends of the elbow 500, for example by embedding conical sockets in the ends of the sheaths 590.1 present at the first end 510 of the elbow 500. The other end 591 of the wires 590 is then used to tension each wire 590. This end is next embedded in the wall of the housing 514 (FIG. 31.g).

An annular elastomer seal 515 can then be mounted in the housing 513 and/or 514 in order to provide a sealed connection of the end of a pipe introduced into the housing 512 with the second end 511 of the elbow 500.

The above method can obviously also be implemented without the placing of the wires 590 and their sheaths 590.1.

Naturally, the invention is not limited to the embodiments described but encompasses any variant falling within the scope of the invention as defined by the claims.

The method according to the invention is thus also applicable to the moulding of portions of tubular or hollow parts, such as for example hemispheres or portions of large-diameter tubes. In this case, the internal element (the core) is rigid—for example made from metal—and the external element (the mould) is deformable on demand, for example produced from wax or polymer. Since the shrinkage of the UHPFC is interfered with neither on the arc of the core nor in the flexible mould, the part does not undergo any stressing during setting.

In particular,
although here the method of the invention is described in relation to the manufacture of a pile, the invention also applies to the manufacture of other types of part, such as for example tubular parts of the pipe or duct type as well as tubular parts at least one end of which is closed, such as tanks, linings, connection boxes or posts, but also multitubular wall parts such as honeycomb slabs or façade panels;
although here the method of the invention is described in relation to the manufacture of a pile with a 200 mm outside diameter, the invention also applies to the manufacture of piles with a different diameter, preferentially between 120 and 240 millimetres but also diameters of less than 120 millimetres or greater than 240 millimetres;
the pile may have forms, internal and/or external, other than those described;
although here the core is provided with conical centring protuberances, the invention also applies to a core with no such protuberances, or provided with other centring means such as studs or rings;
the invention also applies to other forms of associated cavities and protuberances such as for example serrations, pyramidal indentations or of any shape;
although here the mould comprises two half-moulds provided with notched tongues intended to cooperate with wedging catches, the invention also applies to a mould able to separate into more than two parts and the parts of which are connected together by other connection means such as for example straps, bolts, an assembly by bolted flanges, or jacks;
although here the casing of the core is made from silicone, the invention also applies to other types of polymer such as for example rubber, PVC or coated fabric;
although here the core is conformed by filling with water and solidification thereof, the invention also applies to other means for conforming the core, such as for example inflation with compressed air;
although here the reception volume is filled by injection of UHPFC under pressure, the invention also applies to a gravity introduction of UHPFC into the reception volume;
although here the core 60 comprises three cylindrical wax elements connected together by wax shafts, the invention also applies to a single-piece wax core or one produced from the assembly of a different number of elements;
although here the wax core is heated by the injection of hot water or expanded steam in and on the core or by means of a heating braid placed in the core, the invention also applies to other means of heating the core such as for example heating in an oven, by induction or microwaves, or by the use of longitudinal prestressing bars such as electric elements;
although here the centring wedges are made from silicone and attached to the core, the invention also applies to other types of centring wedge such as wedges produced from other polymer materials or centring wedges in the form of a protrusion provided when the core elements are produced;
although here the centring wedges are substantially conical in shape, the invention also applies to other shapes of wedge such as for example wedges with a cylindrical, pyramidal or any shape;
although here the placing of one or two metal collars has been described in relation to a wax core, the invention also applies to the placing of one or two metal collars in the context of use of any other type of core, such as for example an elastomer core;
although here the method has been described in the context of the use of UHPFC, the invention also applies to the use of other material comprising cement, such as for example standard concrete or mortar;
although here the method has been described in relation to the moulding of an externally smooth tube the internal surface of which is engraved, the invention also applies to other surface state configurations, such as for example tubes where the internal face is smooth and the external face is engraved;
although here the method has been described in the context of the moulding of a complete tubular element, the invention also applies to the production of half-tubes or fractions of tube of large diameter. In this case, the mould and the core are semi-cylindrical;
although here the method has been described for an externally smooth tube formed internally, it also applies to internally smooth tubes formed externally, in this case, the internal core is rigid and the external mould is deformable (made from wax or polymer). The shrinkage of the UHPFC is then constrained neither on the arc of the core nor in the flexible mould;
although here the centring of the core has been achieved by means of three prestressing wires, the invention also applies to a different number of prestressing wires, such as for example two, or more than three;
although here the diameter of the prestressing wires is four millimetres, the invention also applies to prestressing wires with a smaller or larger diameter, lying between one and twenty millimetres;
although here the prestressing wires are anchored over a length of 80 millimetres, the invention also applies to prestressing wires anchored over different lengths, greater or lesser. The distance separating the rings and the thickness of the cladding around the prestressing wires are parameters the values of which, given by way of indication in the description, can be adapted;
although here the method has been described for moulding a complete tube, it also applies to the production of half-tubes or fractions of tubes of large diameter. In this case, the mould and the core are semi-cylindrical;
although here the method has been described for an externally smooth tube formed internally, it apples to internally smooth tubes formed externally or for tube portions. In this case, the internal core is rigid and the external mould is deformable on demand. In this configuration, the shrinkage of the UHPFC is constrained neither on the arc of the core nor by the deformable mould;
although here the method has been described for a tube, it also applies to the moulding of beams with a straight bottom flange and a curved top flange connected by a web. In this case, deformable cores disposed on either side of a web (prefabricated or defined by the mould) take the form of a peripheral wax band;
although here the prestressing means comprise two prestressing mechanisms fitted at each end of the prestressing wires, the invention also applies to a mould comprising a single prestressing mechanism applied to a first end of the prestressing wires, the other end being locked against the butt plate of the mould by an anchoring;
although here the means for moving the plate of the prestressing means with respect to the butt plate comprise two CHC screws, the invention also applies to other movement means such as for example a single screw or more than two screws, a cam or a cylinder;
although here the prestressing means are secured to the mould and bear thereon, the invention also applies to means for prestressing the mould separate from the mould and/or which do not come into abutment thereon, such as for example a winch, a Tirfor or a jack, but also props anchored in the ground associated with transverse joint beams, concrete or steel longitudinal stays associated with transverse joint beams, the prestressing bars being anchored behind the joint beams;
although here the prestressing devices are metal wires, the invention also applies to other types of prestressing device such as for example metal bars or reinforcements made from synthetic materials;
although here the pile comprises four radial connection channels emerging on a peripheral groove, the invention also applies to a different number of channels, such as for example between one and three or more than four channels. These channels may also extend in directions that are not radial, as long as the distal end of these channels emerges on the external peripheral groove of the pile. Thus the core may comprise a number of protrusions between one and three or more than four, the protrusions may also join the ring in any directions;
although here the pile comprises a peripheral external groove, the invention also applies to other means for injecting a material from the internal volume of the pile towards the outside thereof, such as for example elastomer valves, ducts or diffusion grilles provided with removable elastomer membranes;
although here the ring mounted at the end of the protrusions of the core is made from elastomer, the invention also applies to other types of ring, such as for example a polystyrene or wax ring, the device for closing off the channels emerging in the groove being able to be mounted after the pile is removed from the mould;
although here the prestressing wires are passed through a collar, such a collar is not essential and the invention also applies to piles comprising prestressing wires (or other prestressing devices);
although here the core comprises a heating braid disposed in a spiral inside a metal tube, the invention also applies to other types of means for heating the core and other types of arrangement such as for example an axial network channeling hot water, steam or a plurality of heating braids positioned inside or outside the tube, the latter being able to be metallic or made from any other suitable material such as for example glass fibre or wood;
although here the core comprises a tube in the form of a straight cylinder, the invention also applies to other forms of support such as for example a square tube, a solid shaft or a tube of any shape;
although here the collar, the ring and the half-jackets of the mould are made from polymer, the invention also applies to other types of suitable material such as for example natural rubber or natural latex;
although here the ring is adhesively bonded along one of its edges, the invention also applies to other means for securing the ring such as for example anchoring or screwing, or to a ring not secured to the groove;
although here the introduction of UHPFC is made when the mould is positioned vertically, the invention also applies to an introduction of material comprising cement in other positions of the mould, such as for example a horizontal mould or one placed at any angle with respect to the horizontal;
although here the measurement of the temperature of the material comprising cement and wax of the core is made by means of a thermocouple, the invention also applies to other temperature measurement means such as for example a measurement by infrared, laser or liquid thermometer, the temperature measurement means being able to comprise only a single device for measuring the temperature solely of the material comprising cement or solely of wax, or a plurality of devices for measuring the temperature of the material comprising cement or wax;
the temperatures and durations of the heat treatment of the material comprising cement are established on the basis of the measurement of the temperature of the material comprising cement, the invention also applies to temperatures and durations of heat treatment used on the basis of other parameters such as for example the surface hardness, the temperature of the core, the moisture level, and the electrical conductivity;
although here the tensioning of the prestressing wires is carried out after the introduction of the material comprising cement into the mould, the invention also applies to a step for tensioning the prestressing wires occurring before the introduction of the material comprising cement into the mould. More generally, the order in which the steps are described may be modified;
although here the elbow is an elbow at ninety degrees, the invention apples to any type of tubular part the longitudinal axis of which comprises a curve portion, such as for example an elbow at fifteen, thirty five, forty five, sixty or any angle.

Within the meaning of the present description, a mortar is a mixture comprising a hydraulic binder composed of cement or a mixture of cement and blast-furnace moulded vitrified slag, detritile rock with a granulometry of between 64 micrometres (μm) and 2 millimetres (mm) within a standard commercial tolerance and any adjuvants such as substances intended to modify the consistency of the mortar, the setting time thereof, the impermeability thereof or the resistance to frost thereof. Finally, the mortar may also comprise synthetic fibres or metal fibres. Reference should be made to NF EN 206-1 for the definition of concretes.

1-15. (canceled)

16. A method for moulding a tubular part from material comprising cement, the method comprising the following steps:
placing at least one pre-stressing device in a cylindrical mould;
placing a core in the cylindrical mould so that the external wall of the core delimits, with the internal wall of the mould, a tubular reception volume, the shape of the core being able to be modified on demand;
arranging a collar at one of the ends of the cylindrical mould;
introducing material comprising cement so as to fill the tubular reception volume;
tensioning the at least one pre-stressing device by applying a tensioning force thereto;
controlling a gradual modification of the shape of the core as the material comprising cement sets until a core shape is obtained enabling it to be extracted from the tubular part after at least partial setting of the material comprising cement;
withdrawal of the core;
prestressing the tubular part by release of the prestressing device;
removal of the tubular part from the mould;
the collar being contained in a cylinder, the outside diameter of which is substantially equal to the outside diameter of the tubular part.

17. The moulding method according to claim 16, comprising a step of applying a heat treatment to the material comprising cement.

18. The moulding method according to claim 16, during which the temperature of the material comprising cement is measured.

19. The moulding method according to claim 17, in which the temperatures and durations of the various phases of the heat treatment step are established according to the measured temperature of the material comprising cement.

20. The method according to claim 16, in which the core is manufactured at least partially from wax.

21. The method according to claim 20, in which the softening point by the ball and ring method of the wax is between 75 and 115 degrees centigrade.

22. The method according to claim 16, in which the ring is made from polymer.

23. The method according to claim 16, in which the collar comprises a radial portion projecting radially towards the inside of the tubular part.

24. The method according to claim 16, in which the core comprises at least one protrusion, the distal part of which joins a ring, so as to create a connecting channel between an internal volume of the tubular part and an external peripheral groove of the tubular part.

25. A tubular pile made from ultra-high performance fibre concrete moulded in accordance with the method of claim 16.

26. A core with a shape that can be modified on demand, comprising a metal tube covered with a layer of wax having a melting point above 115 degrees centigrade.

27. The core according to claim 26, comprising at least one protrusion, the distal part of which joins a ring, so as to create a connecting channel between an internal volume.

28. The core according to claim 26, comprising a metal tube covered with a layer of wax having a melting point above 115 degrees centigrade.

29. The core according to claim 26, comprising heating means.

30. The core according to claim 29, in which the heating means comprise at least one heating braid.
